(19) United States
(12) Patent Application Publication
(10) Pub. No.: US 2013/0182424 A1
(43) Pub. Date: Jul. 18, 2013

(54) HANDHELD LIGHTING DEVICE

(71) Applicants: Tom Staeubli, Zurich (CH); Uwe Werner, Hutten (CH); Arno Lenzi, Zurich (CH); Georgios Margaritis, Schwieberdingen (DE)

(72) Inventors: Tom Staeubli, Zurich (CH); Uwe Werner, Hutten (CH); Arno Lenzi, Zurich (CH); Georgios Margaritis, Schwieberdingen (DE)

(21) Appl. No.: 13/808,143

(22) PCT Filed: Jun. 27, 2011
(86) PCT No.: PCT/EP2011/060683

§ 371 Date: Mar. 21, 2013

(30) Foreign Application Priority Data
Jul. 9, 2010 (DE) 10 2010 031 166.9

(51) Int. Cl. F21L 4/00; F21V 29/00; F21L 4/04

(52) U.S. Cl. CPC F21L 4/00; F21L 4/04; F21V 29/004
USPC 362/191; 362/157

(57) ABSTRACT

A handheld lighting device includes: a hand tool battery coupling unit, a cooling element, and an illuminating device which has an emission direction. The cooling element has at least one outer surface which is situated in the emission direction downstream from an outer surface of the illuminating device, which is transilluminated during operation.

### BACKGROUND OF THE INVENTION

1. Field of the Invention The present invention is directed to a handheld lighting device.

2. Description of the Related Art

A handheld lighting device, which includes a hand tool battery coupling means, a cooling element and an illuminating device which has an emission direction, has already been proposed.

### BRIEF SUMMARY OF THE INVENTION

The present invention is directed to a handheld lighting device which includes a hand tool battery coupling means, a cooling element and an illuminating device which has an emission direction.

It is proposed that the cooling element has at least one outer surface which is situated in the emission direction, downstream from at least one outer surface of the illuminating device which is transilluminated during operation. A “hand tool battery coupling means” is understood to be, in particular, a means which is provided for establishing an electrical and, in particular, a mechanical connection to a hand tool battery of a hand tool. In particular, the term “cooling element,” is understood to be a means which is provided for conducting heat of an illuminant away from the illuminant and/or, in particular, conducting heat of an electronic system away from the electronic system. The cooling element advantageously transfers the heat to ambient air. The cooling element is preferably made largely of metal.

The cooling element preferably has a thermal resistance of less than 8 kelvins/watt, advantageously less than 4 kelvins/watt, particularly advantageously less than 2 kelvins/watt. The cooling element preferably has cooling ribs. The cooling element advantageously is thermally conductively connected at least to the illuminant. An “illuminating device” is understood to be, in particular, a device which emits a luminous flux in an emission direction during operation for the purpose of illuminating, in particular, a work surface. The luminous flux is preferably greater than 100 lumen, particularly preferably greater than 250 lumen. In particular, an “emission direction” is understood to be an average direction of the luminous flux. The illuminating device preferably has an emission angle of less than 270 degrees, advantageously less than 180 degrees, the illuminating device preferably emitting 90% of a power of the luminous flux within the emission angle. An “outer surface” is understood to be, in particular, a surface area which has at least one uninterrupted connection in a straight line toward the outside. The outer surface advantageously has an imaginary connection in a straight line to the outside over at least 90 degrees on at least one plane, this connection, in particular, being uninterrupted by components. In particular, the phrase “situated in the direction downstream from an transilluminated outer surface” is understood to mean that at least one plane, moved toward the illuminating device against the emission direction, first intersects the cooling element and then the illuminating device. A “transilluminated outer surface” is understood to be, in particular, an outer surface of the illuminating device which the luminous flux of the illuminant penetrates last during operation. “Provided” is understood to mean, in particular, specially programmed, configured and/or equipped. Due to the design of the handheld lighting device according to the present invention, the illuminating device is advantageously protected against mechanical effects, in particular due to a drop, through structurally simple, cost-effective and installation space-saving means.

In another embodiment, it is proposed that the illuminating device has at least one illuminant which is designed as an LED, thereby making it possible to achieve a long illumination time with the aid of a hand tool battery and a particularly high reliability and long illuminant life. The LED preferably has an efficiency of at least 75 lumens/watt, advantageously at least 100 lumens/watt. The illuminating device advantageously emits a luminous flux greater than 100 lumens, particularly advantageously greater than 250 lumens in at least one operating state. Alternatively or additionally, the illuminating device may have an illuminant which is designed as an incandescent lamp, a gas discharge lamp, an induction lamp and/or a light-emitting capacitor.

It is furthermore proposed that the cooling element has at least one recess which is situated to permit its transillumination by a luminous flux of the illuminating device, thereby making it possible to particularly efficiently dissipate heat from the illuminant and to advantageously protect the illuminant. A “recess” is understood to be an area delimited by the cooling element which is surrounded by the cooling element by more than 270 degrees on a plane positioned perpendicularly to the direction of illumination. The recess is preferably designed as an opening, for example as a bore. In particular, the phrase “situated to permit its transillumination by a luminous flux,” is understood to mean that the recess is situated downstream from the illuminant in the direction of illumination.

It is furthermore proposed that the handheld lighting device includes a pivoting device which is provided for pivotably mounting the illuminating device, in particular, relative to the hand tool battery coupling means, thereby making it possible to structurally easily and comfortably direct the illuminating device onto a work surface. “Pivotably mounted” is understood to mean, in particular, fixed movably around at least one axis.

It is furthermore proposed that the cooling element is designed to at least partially form a single piece with the pivoting device, thereby making it possible to advantageously reduce structural complexity, installation space and components. In particular, the phrase “at least partially form a single piece” is understood to mean that the cooling element has at least one area which provides the function of the pivoting device. The function could be, for example, to support a bearing force, to protect a pivot area and/or another function which appears meaningful to those skilled in the art.

It is furthermore proposed that the handheld lighting device has an electronics housing which is designed to at least partially form a single piece with the cooling element, thereby making it possible to advantageously reduce structural complexity, installation space and components. In particular, an “electronics housing” is understood to be a housing which is provided for the purpose of protecting the electronic system and/or advantageously fixing the electronic system. The cooling element may advantageously at least partially cool the electronic system.

In one advantageous embodiment of the present invention, it is proposed that the illuminating device has an optical system which is situated at least partially upstream from the outer surface of the cooling element, viewed in the emission direction, thereby making it possible to advantageously protect the optical system and provide good heat dissipation of the cooling element through structurally simple means. An “optical system” is understood to be a device for changing and/or for advantageously conducting the luminous flux. The optical system preferably has at least one lens and/or preferably one reflector. The optical system is advantageously situated at least partially in the recess, thereby making it possible to save installation space.

In another embodiment, it is proposed that the illuminating device has a diffuser optical system, thereby making it possible to achieve a particularly uniform, low-glare and, in particular, wide luminous flux. A “diffuser optical system” is understood to be, in particular, an optical system which is provided for widening the luminous flux. The diffuser optical system advantageously controls the light beam.

It is furthermore proposed that the diffuser optical system is movably mounted, in particular, relative to the illuminant, thereby making it possible to advantageously activate and deactivate the diffuser optical system through structurally simple means. The diffuser optical system is preferably mounted rotatably around an axis. The diffuser optical system is preferably mounted to rotate by 90 degrees in the case of two LEDs, by 60 degrees in the case and of three LEDs and by 45 degrees in the case of four LEDs.

It is furthermore proposed that the handheld lighting device has a fixing means which is largely made of a rubber-like material, thereby making it possible to provide a cost-effective and versatile fixing means. A “rubber-like material” is understood to be, in particular, a material which is at least partially elastically deformable, advantageously elastically deformable, by at least 10%, advantageously by 20%. For example, rubber-like materials are rubber, neoprene, silicone, latex and/or other materials which appear meaningful to those skilled in the art. The fixing means is preferably designed in the shape of a strap. Alternatively or additionally, the fixing means may have at least one elastic element, in particular a helical spring.

### BRIEF DESCRIPTION OF THE DRAWINGS

FIG. 1 shows a perspective view of a system which includes a handheld lighting device according to the present invention and a hand tool battery.

FIG. 2 shows a section of the handheld lighting device from FIG. 1.

FIG. 3 shows an exploded view of the handheld lighting device from FIG. 1.

FIG. 4 shows a detailed view of the hand tool battery coupling means from FIG. 1.

FIG. 5 shows a perspective view of another exemplary embodiment of the handheld lighting device according to the present invention from FIG. 1.

FIG. 6 shows a section of the handheld lighting device from FIG. 5.

FIG. 7 shows an exploded view of the handheld lighting device from FIG. 5.

FIG. 8 shows a cover and a shell section of the handheld lighting device from FIG. 5 in a cutaway representation.

### DETAILED DESCRIPTION OF THE INVENTION

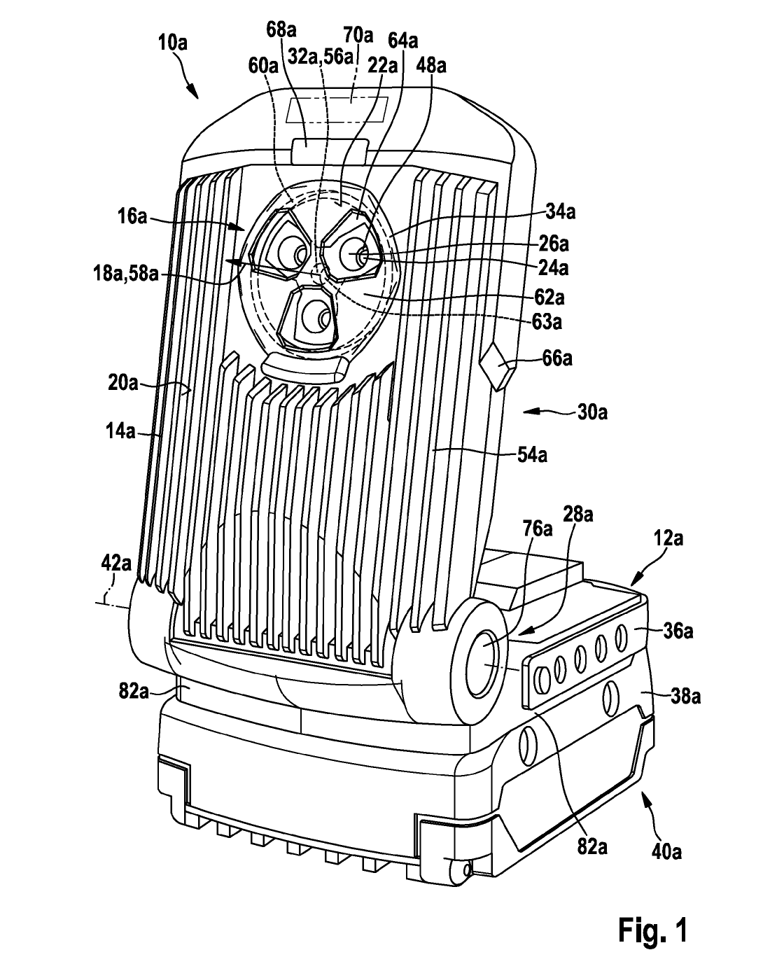

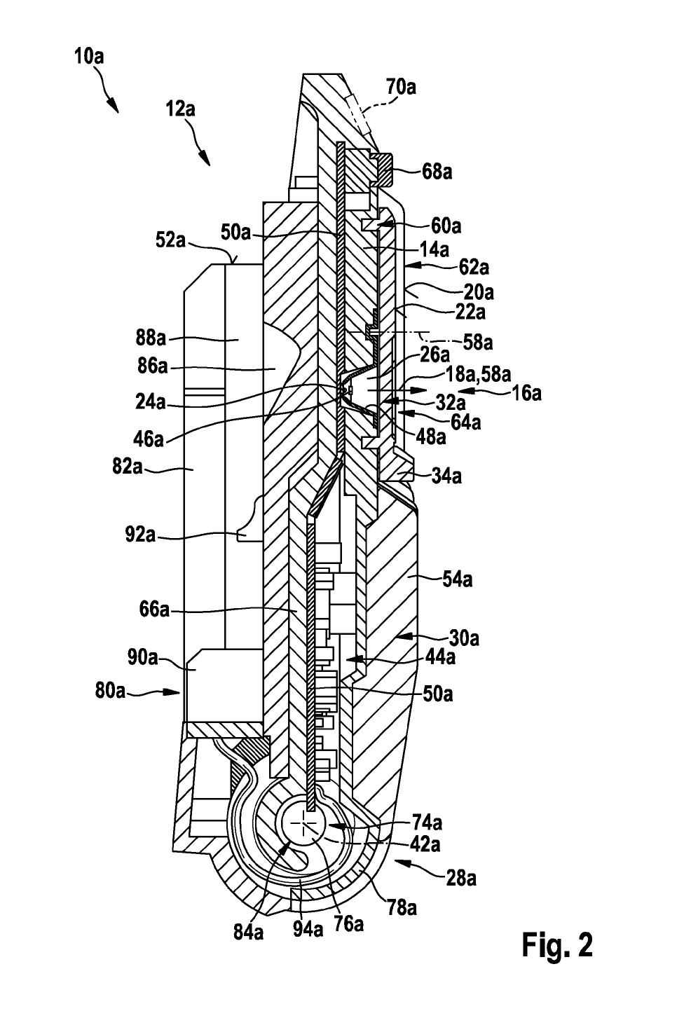

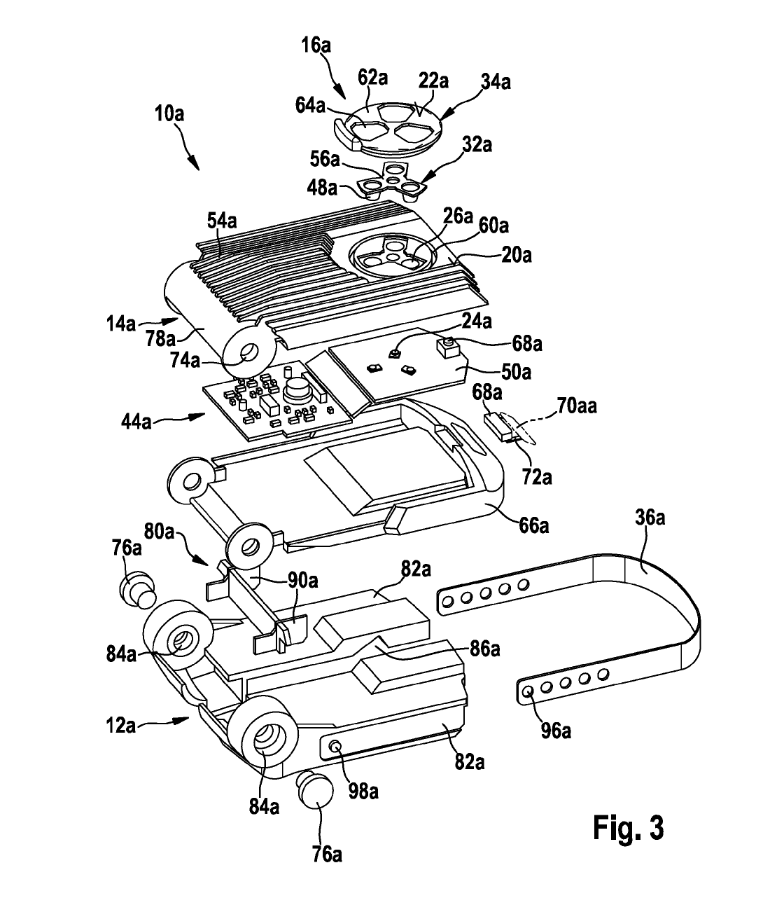

FIG. 1 shows a system 40a which includes a hand tool battery 38a and a handheld lighting device 10a. As illustrated in greater detail, in particular in FIGS. 2, 3 and 4, handheld lighting device 10a includes a hand tool battery coupling means 12a, a pivoting device 28a and an illuminating body.

Pivoting device 28a pivotably supports hand tool battery coupling means 12a around a pivot axis 42a, relative to the illuminating body.

The illuminating body includes a cooling element 14a, an illuminating device 16a, an electronics housing 30a and an electronic system 44a. Illuminating device 16a emits a luminous flux in an emission direction 18a of illuminating device 16a during operation. Illuminating device 16a has three illuminants 24a and an optical system 32a for this purpose. Illuminants 24a are designed as power LEDs. Each of illuminants 24a emits a portion of the luminous flux at 90 lumens. Optical system 32a includes lenses 46a and reflectors 48a.

Cooling element 14a cools illuminants 24a during operation. Illuminants 24a are situated on a p.c. board 50a of electronic system 44a and are thermally coupled with p.c. board 50a using a heat conducting film. Cooling element 14a is thermally coupled with p.c. board 50a adjacent to illuminants 24a. For this purpose, a contact surface 52a of cooling element 14a is located directly adjacent to p.c. board 50a, and contact surface 52a is pressed against p.c. board 50a. This contact surface 52a is larger than 2 cm². It surrounds each of illuminants 24a by 360 degrees. Contact surfaces 52a are preferably also coupled with a heat conducting film. Alternatively or additionally, cooling element 14a, illuminant 24a and/or p.c. board 50a may be coupled in a different, specially heat conducting way which appears meaningful to those skilled in the art, for example using a heat conducting adhesive and/or a heat conducting paste, thereby enabling tolerances, in particular of cooling element 14a, to be particularly advantageously bridged through heat conducting means.

Cooling element 14a has outer surfaces 20a which are situated in emission direction 18a, downstream from an outer surface 22a of illuminating device 16a which is transilluminated during operation. These outer surfaces 22a are situated on cooling ribs 54a of cooling element 14a. Cooling ribs 54a are designed as molded parts which extend in emission direction 18a and in the direction of pivoting device 28a on a side of cooling element 14a facing away from contact surface 52a. The cooling ribs surround the luminous flux by approximately 270 degrees on a plane which is perpendicular to emission direction 18a. Cooling element 14a is manufactured from die cast aluminum.

Cooling element 14a has three recesses 26a. Recesses 26a have a conical design and extend in the direction of outer surface 20a. Recesses 26a are situated to permit their transillumination by portions of the luminous flux of illuminants 24a. For this purpose, illuminants 24a are situated on a side of recess 26a facing away from outer surfaces 22a. Lenses 46a and reflectors 48a are situated in recesses 26a. These lenses and reflectors are connected by webs 56a. They may thus be extruded in one single work step and mounted in one single work step. Reflectors 48a are vapor-deposited. Optical system 32a is thus situated upstream from outer surface 20a of cooling element 14a, viewed in emission direction 18a. Alternatively, an optical system may have only one or multiple lenses or one or multiple reflectors.

Illuminating device 16a has a diffuser optical system 34a. Diffuser optical system 34a is situated downstream from recesses 26a of cooling element 14a in emission direction 18a. Diffuser optical system 34a is movably mounted around a rotation axis 58a. For this purpose, diffuser optical system 34a is secured in an annular groove 60a of cooling element 14a. Annular groove 60a also prevents dirt from penetrating between diffuser optical system 34a and illuminants 24a. Alternatively or additionally, a diffuser optical system may be fixed in place with the aid of a fixing means which penetrates the cooling element, in particular with the aid of a screw connection. Diffuser optical system 34a has three diffuser areas 62a. Diffuser areas 62a are situated symmetrically around rotation axis 58a. Diffuser areas 62a are connected by a centrally situated diffuser area 63a. Centrally situated diffuser area 63a optically covers an attachment of diffuser optical system 34a. Diffuser areas 62a, 63a merge seamlessly into each other.

If diffuser areas 62a are situated upstream from illuminants 24a, diffuser areas 62a scatter the light penetrating them at an emission angle of more than 120 degrees. Diffuser areas 62a are frosted for this purpose. Alternatively, a surface design of one diffuser area could scatter a luminous flux. Moreover, diffuser optical system 34a also has clear areas 64a which allow the light penetrating them to pass largely unscattered. Clear areas 64a are offset relative to diffuser areas 62a in the direction of illuminants 24a. Clear areas 64a are thus advantageously protected against scratching. Other areas of diffuser optical system 34a could be provided with a frosted design, in particular for optically covering components or for design purposes.

Electronics housing 30a is designed to partially form a single piece with cooling element 14a, and cooling element 14a forms a cover of the electronic system positioned in emission direction 18a. A cover 66a of electronics housing 30a positioned counter to emission direction 18a is formed by a plastic part. Cover 66a presses electronic system 44a partially against cooling element 14a. Cooling element 14a thus partially cools electronic system 44a. A seal, which is not illustrated in further detail, is situated between cooling element 14a and cover 66a. When cooling element 14a and cover 66a are assembled, p.c. board 50a is deformed and stepped at defined points. Cooling element 14a is screwed to cover 66a. Cooling element 14a is adjusted to a different height of components of electronic system 44a.

Electronic system 44a has a constant current source. The constant current source supplies illuminating device 16a with electrical power. The electrical power is constant during operation. At a temperature of cooling element 14a above 60 degrees, electronic system 44a reduces an electrical power supplied to the illuminating device. The constant current source generates a current required by illuminants 24a from a voltage of hand tool battery 38, in particular 14.4 volts and/or 18 volts. Alternatively or additionally, electronic system 44a could have a constant voltage source and/or another power source which appears meaningful to those skilled in the art.

Handheld lighting device 10a has an operating element 68a. Operating element 68a is electrically connected to electronic system 44a. An operator may thus turn illuminating device 16a on and off and vary a luminosity of illuminating device 16a. Operating element 68a is injection molded as a single piece with a logo 70a. Two webs 72a connect operating element 68a to logo 70a, webs 72a movably fixing operating element 68a to logo 70a.

Cooling element 14a is designed to partially form a single piece with pivoting device 28a. Cooling element 14a has two recesses 74a in an area facing away from illuminating device 16a. In an operational state, two bearing and fixing elements 76a of pivoting device 28a engage with recesses 74a. Pivot axis 42a runs through the center of recesses 74a. Pivot axis 42a is oriented perpendicularly to emission direction 18a. Cooling element 14a also has a pivoting cover 78a. Pivoting cover 78a is designed in the shape of a partial tube. When pivoting device 28a is pivoted up, pivoting cover 78a partially pivots into hand tool battery coupling means 12a. The pivoting device secures hand tool battery coupling means 12a in multiple positions relative to illuminating device 16a.

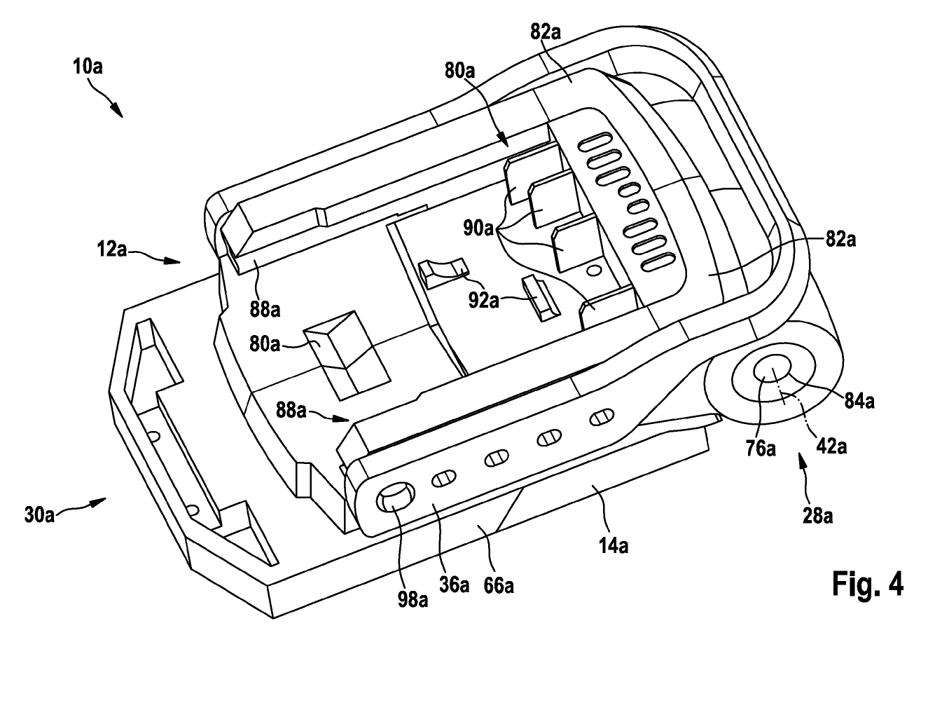

As is apparent, in particular, from FIG. 4, hand tool battery coupling means 12a has a contact element 80a and two shell sections 82a which include recesses 84a, securing areas 86a and fixing areas 88a. The two shell sections 82a are screwed to each other. In an operational state, the two bearing and fixing elements 76a of pivoting device 28a engage with recesses 84a. Securing areas 86a and fixing areas 88a mechanically fix hand tool battery 38a in an operational state. Contact element 80a has electrically conductive contacts 90a and coding means 92a. Contacts 90a contact hand tool battery 38a. Coding means 92a prevent a hand tool battery 38a from being unintentionally attached. Contact element 80a is inserted into shell sections 82a. Contact element 80a is connected to electronic system 44a via a cable harness 94a.

Handheld lighting device 10a also has a fixing means 36a. Fixing means 36a is designed as a strap made of a rubber-like material, in particular as an injection molded elastomer. Fixing means 36a has multiple holes 96a. The cover has two posts 98a which engage with two of holes 96a of fixing means 36a. An advantageous adjustability and mobility are thus achieved. For example, handheld lighting device 10a may be suspended and clamped firmly in place with the aid of fixing means 36a.

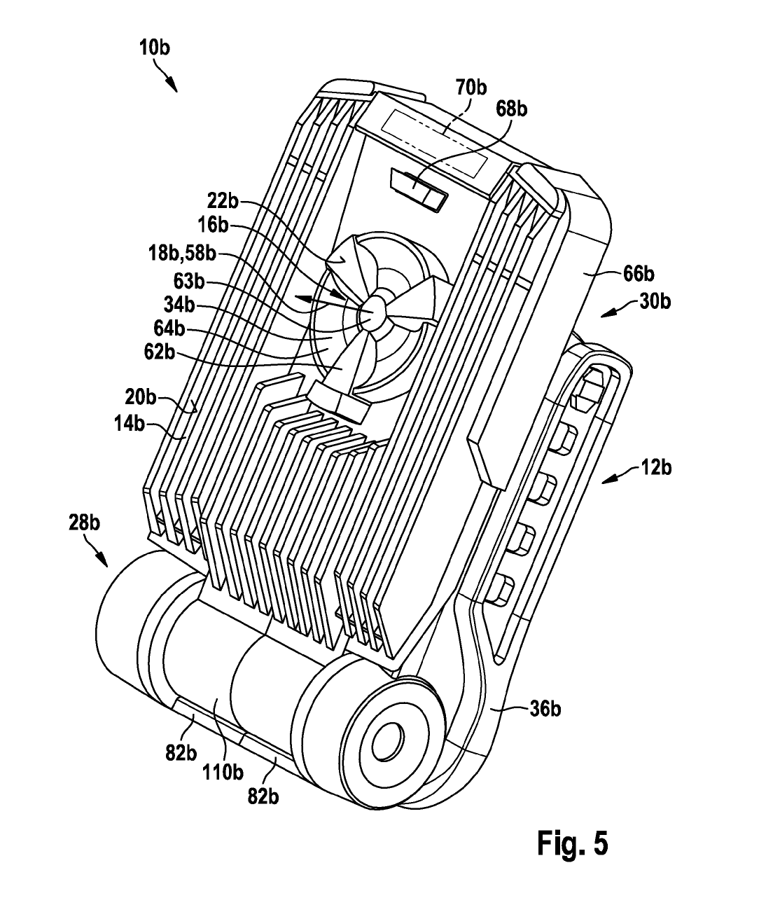

FIGS. 5 through 8 show an additional exemplary embodiment of the present invention. The following descriptions and drawings are largely limited to the differences between the exemplary embodiments, it being possible to refer, in principle, to the drawings and/or descriptions of the other exemplary embodiments with regard to equivalent components, in particular in reference to components having the same reference numerals. To distinguish between the exemplary embodiments, the letter a is placed after the reference numerals of the exemplary embodiment in FIGS. 1 through 4. The letter a is replaced by the letter b in the exemplary embodiment in FIGS. 5 through 8.

FIG. 5 shows a handheld lighting device 10b which includes a hand tool battery coupling means 12b, a cooling element 14b, an illuminating device 16b and a pivoting device 28b. Illuminating device 16b emits a luminous flux in an emission direction 18b of illuminating device 16b during operation. Cooling element 14b has an outer surface 20b. Outer surface 20b is situated in emission direction 18b, downstream from an outer surface 22b of illuminating device 16b, which is transilluminated during operation.

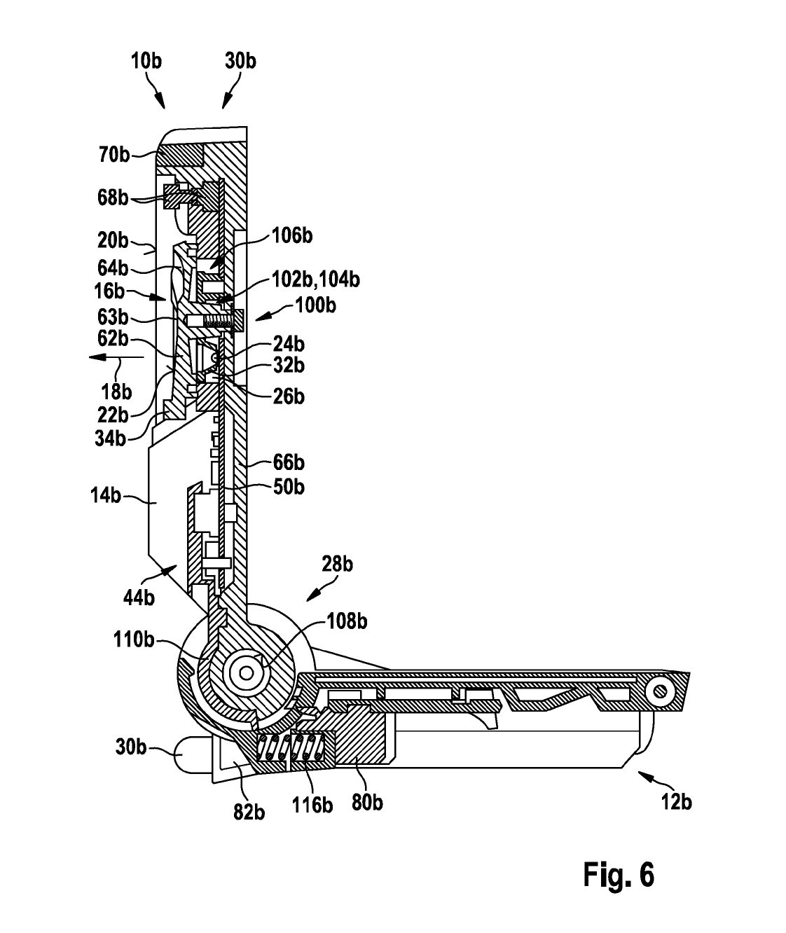

Handheld lighting device 10b has an electronics housing 30b, an electronic system 44b, an operating element 68b and a logo 70b. As is apparent, in particular, from FIG. 6, operating element 68b is designed separately from the logo, i.e., in particular, it is manufactured separately. Operating element 68b is situated downstream from outer surface 20b of cooling element 14b in emission direction 18b, thereby making it possible to avoid unintentional actuation of operating element 68a. Operating element 68a is partially fixedly connected to a p.c. board 50b of electronic system 44b. P.c. board 50b is mounted in electronics housing 30b without sharp bends. P.c. board 50b is also designed as a single piece.

Illuminating device 16b has three illuminants 24b and a diffuser optical system 34b. Diffuser optical system 34b has diffuser areas 62b, 63b and clear areas 64b. Outer surfaces of diffuser areas 62b, 63b are situated downstream from outer surfaces of clear areas 64b, viewed in emission direction 18b, making it possible to avoid scratching clear areas 64b. Diffuser optical system 34b has a fixing means 100b, which penetrates a recess 102b of cooling element 14b in an operational state. Fixing means 100b also penetrates a recess 104b of p.c. board 50b. Fixing means 100b is designed as a screw connection.

Illuminating device 16b has an optical system 32b. Optical system 32b is designed as a single piece for all illuminants 24b. Cooling element 14b has three recesses 106b. Optical system 30b engages with recesses 106b. Optical system 32b is fixedly connected to p.c. board 50b through recesses 106b. Optical system 32b has one reflector 48b for each illuminant 24b.

Electronics housing 30b has a cooling element 14b and a cover 66b. Cover 66b is designed as a plastic part. It forms an area of electronics housing 30b positioned counter to emission direction 68a. Cover 66b and cooling element 14b are designed to partially form a single piece with pivoting device 28b. Cover 66b has bearing surfaces 108b of pivoting device 28b. These bearing surfaces are situated within an annular area 112b of the cover. Cooling element 14b has a cover 110b of pivoting device 28b.

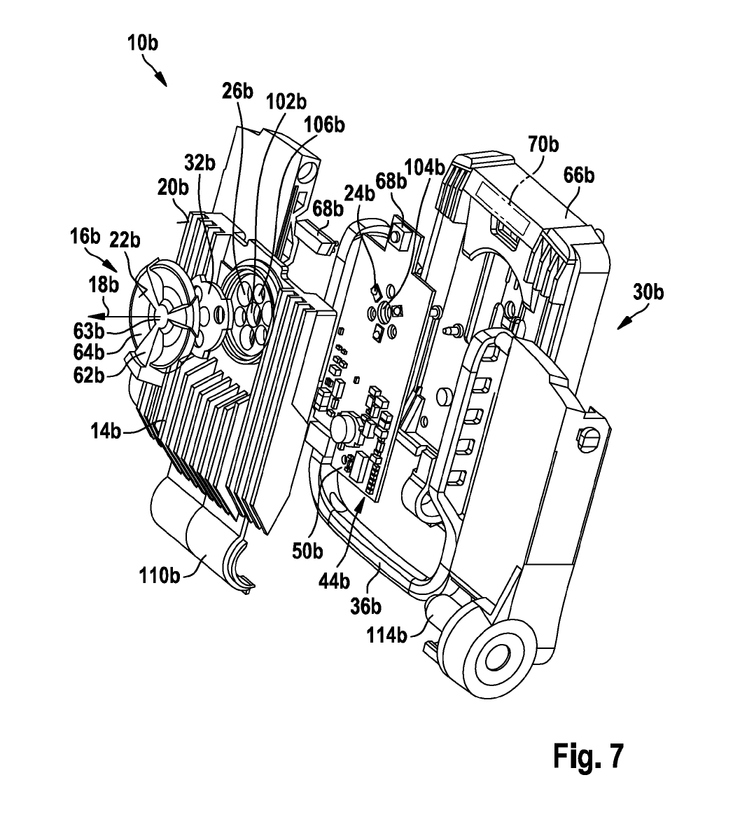

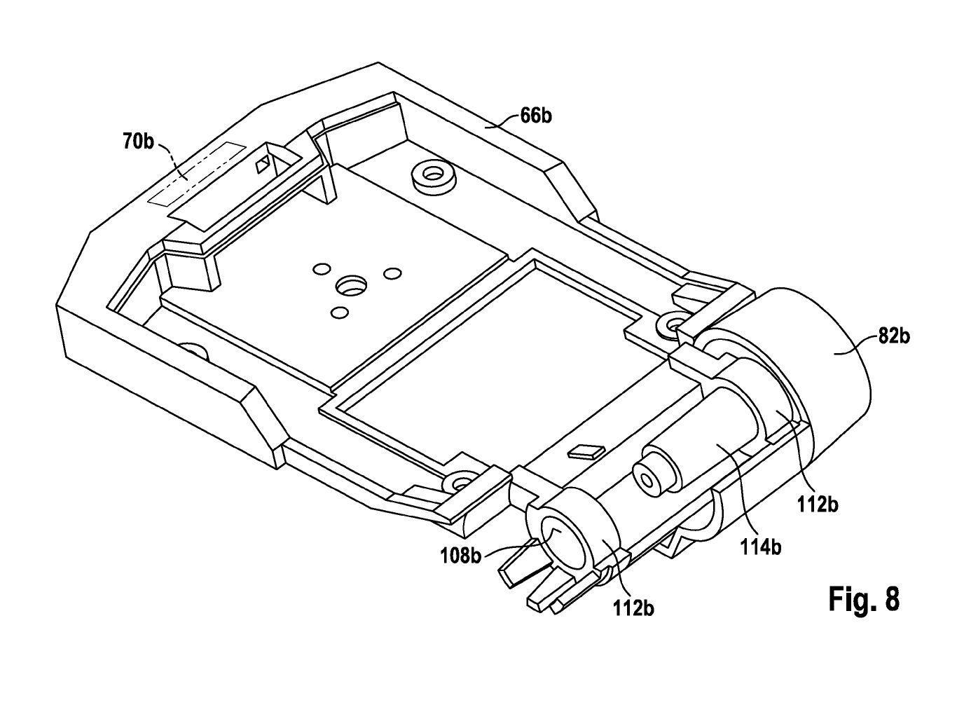

As is apparent, in particular, from FIGS. 7 and 8, hand tool battery coupling means 12b has a contact element 80b, two shell sections 82b and a spring 116b. Shell sections 82b have dome-shaped molded parts 114b of pivoting device 28b. Molded parts 114b penetrate annular areas 112b of pivoting device 28b. Dome-shaped molded parts 114b of the two shell sections 82b are screwed to each other. Spring 116b is situated between contact element 80b and shell sections 82b. Spring 116b applies an elastic force to contact element 80b in the direction of a hand tool battery, which is not illustrated in further detail. This permits a particularly reliable contacting. A clearly audible clicking into place may also be achieved with the aid of the spring.

1-11. (canceled)

12. A handheld lighting device, comprising:
a hand tool battery coupling unit;
an illuminating device which has an emission direction; and
a cooling element which has at least one outer surface situated in the emission direction, downstream from at least one outer surface of the illuminating device which is transilluminated during operation.

13. The handheld lighting device as recited in claim 12, wherein the illuminating device has at least one illuminant configured as an LED.

14. The handheld lighting device as recited in claim 12, wherein the cooling element has at least one recess positioned to be transilluminated by a luminous flux of the illuminating device.

15. The handheld lighting device as recited in claim 12, further comprising:
a pivoting device provided to pivotably mount at least the illuminating device.

16. The handheld lighting device as recited in claim 15, wherein the cooling element is configured to at least partially form a single piece with the pivoting device.

17. The handheld lighting device as recited in claim 12, further comprising an electronics housing which is configured to at least partially form a single piece with the cooling element.

18. The handheld lighting device as recited in claim 12, wherein the illuminating device has an optical system which is situated at least partially upstream from the at least one outer surface of the cooling element, viewed in the emission direction.

19. The handheld lighting device as recited in claim 18, wherein the illuminating device has a diffuser optical system.

20. The handheld lighting device as recited in claim 19, wherein the diffuser optical system is movably mounted.

21. The handheld lighting device as recited in claim 20, further comprising:
a fixing unit which is predominantly made of a rubber-like material.

22. The handheld lighting device as recited in claim 19, further comprising a hand tool battery.
